(19) United States
(12) Patent Application Publication
(10) Pub. No.: US 2014/0324882 A1
(43) Pub. Date: Oct. 30, 2014

(54) METHOD AND SYSTEM FOR NAVIGATING COMPLEX DATA SETS

(71) Applicants: Tummarello GIOVANNI, Trento (IT); Delbru RENAUD, Galway (IE)

(72) Inventors: Tummarello GIOVANNI, Trento (IT); Delbru RENAUD, Galway (IE)

(21) Appl. No.: 14/264,762

(22) Filed: Apr. 29, 2014

(30) Foreign Application Priority Data
Apr. 30, 2013 (GB) 1307814.2

(51) Int. Cl. G06F 17/30

(52) U.S. Cl. CPC G06F 17/30327
USPC 707/742

(57) ABSTRACT

The present invention relates to systems and methods for storing, navigating and retrieving information. In particular, the present invention is concerned with systems and methods for storing data in, for retrieving data from, and for navigating large and/or complex datasets. The systems and methods of the present invention in particular are concerned with the materialization/denormalization of complex data sets comprising a plurality of large, interconnected but distinct data record collections. The materialization/denormalization of such data sets can be performed in a precomputation phase, prior to a browsing/searching operation.

### CROSS-REFERENCE TO RELATED APPLICATIONS

The present application claims priority under 35 U.S.C. §119(a) of British Patent Application No. 1307814.2 filed Apr. 30, 2013, which is expressly incorporated by reference herein in its entirety.

### BACKGROUND OF THE INVENTION

1. Field of the Invention

The present invention relates to systems and methods for storing, navigating and retrieving information. In particular, the present invention is concerned with systems and methods for storing data in, for retrieving data from, and for navigating large and/or complex datasets.

2. Discussion of Background Information

As continued improvements are made to computing power and network speeds, increasing amounts of data are being stored and being made accessible to users throughout the world. As the amount of data handled in this way increases, the size and complexity of individual data sets also increases. In tandem with this increase in data handling is an increase in the level of user demand for the stored data, with users' demands for specific information stored within these increasingly large and complex data sets becoming larger, increasingly frequent and more sophisticated.

As the size and complexity of data sets increases, the difficulty in providing users with an intuitive way of being able to navigate these data sets also increases. In addition, the challenge of returning only relevant results pertinent to users' queries also increases. In particular, there is a real and increasingly significant challenge in providing a user-friendly interface that is flexible and intuitive enough to allow users to navigate complex data sets using increasingly sophisticated queries. In addition, a challenge also exists in ensuring that suitable interfaces are economical in terms of the computing resources they use (i.e. storage, processing requirements, etc), and are therefore scalable so that they can deal with data sets of a wide variety of sizes and levels of complexity.

The traditional way of dealing with sophisticated user queries has been to use a faceted data classification scheme associated with a faceted navigation system. Using such a classification scheme and associated navigation system allows users to find information without a-priori knowledge of its schema. Faceted classification schemes are used to describe each data record in a data set by a collection of independent facet categories. More particularly, in faceted classifications, the information space is partitioned using orthogonal conceptual dimensions of the data. These dimensions are called facets and represent important characteristics of the data records. Each facet has multiple restriction values and, when navigating via an associated faceted navigation system, the user selects a restriction value to constrain relevant records in the information space. The values in a facet may be organized:
1. In a simple list from which the user can make a selection, e.g. from a list allowing single or multiple choices
2. hierarchically with more general topics at the higher levels of the hierarchy and more specific topics towards the leaves;
3. on a timeline if the values represent time information;
4. on a map if the values represent geo-localisation information; or
5. other visual concepts depending on their types.

For example, a collection of art works can have facets such as type of work (e.g. watercolour painting, oil painting, etc), time periods, artist names and geographical locations. Users navigating a data set ordered in such a way are able to constrain each facet to a restriction value, such as “created in the 20th century”, in order to limit the visible collection to a subset. Other restrictions can be applied on a step-by-step basis to further constrain the information space. A faceted browser might also allow other restrictions e.g. based on a keyword search across all or some of the fields.

A faceted classification scheme is a more economic and compact data taxonomy than single-hierarchy taxonomies and they are sufficiently flexible to accommodate the addition of new dimensions of information (i.e. facets) at future dates without undue effort. In addition, faceted navigation systems are preferable to simple keyword searches or explicit queries because they allow exploration of an unknown dataset. Since the system suggests restriction values at each step; it is a visual interface, removing the need to write explicit queries; and it prevents dead-end queries, by only offering restriction values that do not lead to empty results.

Nevertheless, there are problems with these faceted classification schemes and associated navigation systems. They fail to facilitate the navigation of complex data sets that comprise more than a single collection of data records, when the collections have a relational structure. In particular, such systems cannot accommodate navigation where users' constraints apply to more than one related collection of data records and/or where the set of matching data records depends on the relationships between data records from different collections of records.

For example, the data schema depicted in FIG. 1 comprises three collections of data records, these records being interrelated. The first collection comprises a list of museums along with the associated facets of “name”, “location” and “display”, the second collection comprising a list of artworks comprising the associated facets of “title”, “period” and “created by”, and the third collection comprising a list of artists comprising the associated facets of “name” and “nationality”. Each artwork is associated with at least one museum and similarly, each museum is associated with at least one artwork, based on whether a given work has ever been displayed in a given museum, This relationship is represented by the arrow emanating from the “display” facet, with the “N:N” ratio being representative of this “one or more”-to-“one or more” relationship. Additionally, each artwork is associated with a single artist, while each artist is associated with one or more artwork, as represented by the arrow emanating from the “created by” facet, with the “N:1” ratio being representative of this “one or more”-to-“one” relationship. Each artwork accordingly will have associated information regarding its artist and the museums in which it has been displayed (e.g. the nationality of the artist or the location of the museums it has been displayed in), but this information is not comprised directly in the “artwork” collection itself. Accordingly, the disadvantage of the traditional faceted classification scheme and navigation system is that it would not—for example—be possible to perform faceted searching of artworks by artist nationality or by museum location (or both), because this information is not directly comprised in the “artwork” data record collection.

A first solution (the “first denormalization solution”) to addressing this problem has been to denormalize the dataset in order to incorporate the data from the three existing record collections into a single collection of master data records. This can be done by designating one of the three record collections as the “primary record collection”, and designating the other two as the “secondary” record collections. The secondary record collection data, and the corresponding interrelationship data can then be incorporated into a single collection of master data records based on the “primary” record collection. For example, in the sample dataset depicted in FIG. 2, the “Artwork” data record collection could be designated as the primary record collection and used as the basis for a collection of master data records, where additional facets from the secondary data record collections (in this case the “Museum” and “Artist” collections) are added to each artwork data record in order to create the master data records, these additional facets comprising “Artist.name”, “Artist.nationality”, “Museum.name” and “Museum.location”. An example of such a master data record is pictured in FIG. 3 for the record “ArtWork 2” from the example shown in FIG. 2. It is to be noted that the “display” and “created by” facets of the Museum and Artwork record collections are not expressly included in this master data record, because these facets merely provided the relational information for associating the secondary datasets with the primary data set. Once the data set has been denormalized, this information is no longer required. This solution, however, is not practical for large datasets, because each record in the secondary record collections must be reproduced for every associated record in the primary record collection, leading to a large amount of duplication of information.

In addition, this first denormalization solution cannot deal in a satisfactory manner with complex interrelationships where a data record has relationships with multiple records in another collection. While the temptation in such a scenario would be to “flatten” the dataset by including additional facet values in each record bearing such multiple relationships, this can lead to the return of false positives during a search. This problem is illustrated in FIG. 3, where the artwork in question has been displayed by two museums, the first museum having the name “Guggenheim” and location “Bilbao”, and the second having the name “Modern Art” and location “New York”. A user searching such a flattened dataset for artworks displayed by a museum with the name “Guggenheim” and having the location “New York” would return the aforementioned artwork, even though it was never displayed by the Guggenheim Museum in New York. Accordingly, this form of denormalization is sub-standard because certain information is lost during the denormalization operation (in this case the connection between individual museum names and locations).

There exists a second solution (the “second denormalization solution”) to address the shortcomings of traditional faceted classification schemes and navigation systems. This second denormalization solution does not suffer from the data loss and false positive problems associated with the first denormalization solution described above. In this second solution, a new master data record is created for each relationship. In the above example, for instance, two records would be created for the artwork in question as depicted in FIG. 4. The first master record bears the “Museum 1” data (Bilbao) while the second bears the “Museum 2” data (New York). This solution essentially denormalizes the data set from a one-to-many to a one-to-one form.

While this solution overcomes the false positive problem associated with the first denormalization solution, it comes with its own problems. Firstly, a search for the artwork in question could produce duplicate results in 1:N, N:1 and N:N type relationships. For example, a user searching artworks created by an American artist would return both records depicted in FIG. 4 in spite of the fact that they pertain to the same artwork. While this issue could be dealt with by passing search results through a filter to remove duplicates, this filter adds to the overall complexity of the system. However, this should not be underestimated, as properly removing a duplicate in the search results can be quite costly. Also of significance, is that the size of the dataset produced via this solution is significantly larger than the original dataset, and can grow substantially if a record in one collection is linked to records from multiple other data record collections. For instance, in the example of FIG. 1, a separate master data record would be required for every Museum-Artwork-Artist combination. It should thus be clear that in scenarios where larger data record collections exist with more complex interrelationships between the records in each collection, the data set produced via the second denormalization solution would increase in size compared to the source data set by an even higher multiple—it would be unfeasibly and unjustifiably large. By way of illustration, FIG. 23 depicts such an increase of complexity. In this example, an artist record in a dataset, e.g., A1, is related to 20 Art Works, and 10 Museums, with each artwork related to each of the ten Museums (i.e. the 10 Museums related to artist A1 are related to all twenty Artworks related to artist A1). The second denormalization approach would result in a collection of 200 master records (one master record per path=1×20×10), wherein each master record comprises three data records. Accordingly, this approach would increase the size of the dataset to 600 records, whereas the original dataset comprised 31 (10+20+1) records. As this is only the scenario for a single artist, it will be readily appreciated that if this is representative of the average number of associations for each artist in a dataset, under the second denormalization solution, the denormalized data set representative of the original data set would be extremely large. Accordingly, the second denormalization solution is not a scalable solution to the limitations of traditional faceted classification schemes and navigation systems. Further still, the second denormalization solution would suffer from the additional drawback of losing information concerning the distinction between values of a multi-valued facet, if it were to be used in conjunction with an inverted index. This is because, due to the limitation of traditional attribute-based inverted indices, these values would be dernomalised into one single value through concatenation. This is equally an additional drawback of the “first denormalization solution”.

Rather than relying on denormalization of the data set, an alternative approach is to facilitate relational (or “pivoted”) faceted browsing using a relational database. While typical faceted navigation systems would allow the user in the example of FIG. 1 to restrict artworks by facets it has directly associated with these data records, e.g. type, name and period, a relational database could allow the collection of artworks to be searched based on the facets associated with one or more artists related to the artwork as well as on the facets related to museums. Also, in such a system, the focus of exploration can typically change from one type to another. For example, the user could start browsing artworks, restrict them using some of their facets (e.g. just those in the impressionist period) and then pivot to the set of artists associated with those artworks that have been selected. This can happen iteratively, e.g. once a constraint is applied to the collection of artists, the user can decide to focus on Museums and see only those that are, relationally via artworks, connected to the artists that were previously selected. At each step the system can enumerate, aggregate and count the facet values that are associated with data records in the current constrained information space.

Relational faceted browsing utilizing relational databases typically involves the creation of a query execution plan that joins tables that are representative of the discrete but related datasets and produces the expected result sets. Joining tables enables the checking of the existence of relationships (or paths) between multiple related collections of data records, and filters out data records that do not satisfy such constraints. This system can be advantageous because the database query operations can be inherent in the pivoted faceted browser functionality such that browsing is facilitated without prior knowledge of the underlying data schema. However the problem with this approach is that joining tables is a resource intensive operation both in terms of computing space and processing power, and this limits the scalability and performance of the system. Furthermore, this operation becomes even more complex with the number of relation types present in the dataset. For example, consider a dataset that is similar to, but larger than, the example in FIG. 1 pertaining to artworks, their artists, and the museums where these artworks have been displayed. To locate all museums that have displayed artworks from American artists, the system would have to join three different tables, creating a query execution plan composed of two joins. This approach makes faceted navigation intractable with even a modest number of data records and data record types.

U.S. Pat. No. 8,019,572 proposes a means of addressing the limitations of both traditional faceted classification schemes and navigation systems that rely on relational databases while at the same time trying to avoid some of the disadvantages associated with the alternative solutions previously identified. This solution avoids the complexity explosion encountered in the denormalization models discussed above by relying instead on a combination of inverted index and relational database technologies. Relational database technology is used to index relationships between records and to create a query execution plan that joins the record tables to produce the expected result sets. Inverted index technology is used to map facet values to records, and enables traditional faceted searching on the collection of records. In the approach of the '572 patent, there is a similarity with the more commonplace form of relational faceted browsing utilizing relational databases as discussed above, in that the relational determination between the data sets is still performed by regular relational database techniques. However, a hybrid approach is used in the '572 patent, where subsequent to the use of relational technology to first used to filter out records that do not satisfy the relational constraints, inverted index technology is used to compute the aggregates over the set of constrained records. This approach is slightly more efficient than a purely relational approach, in the sense that the use of inverted index technology allows the enumeration and aggregation of facet values to be done efficiently. The enumeration and aggregation of facet values are partially precomputed at indexing time and stored in the inverted index, while in the case of the purely relational database technology, the enumeration and aggregation of facet values must be computed at query time. The problem—as acknowledged by the authors of this document—is that this approach remains onerous in terms of computational requirements. As mentioned already, joining tables is an expensive operation both in terms of space (i.e., memory) and time (i.e., CPU), limiting the scalability and performance of the system. The problem increases in complexity with the number of data record types and relation types present in the dataset.

It is perhaps in light of the above drawbacks that relational faceted browsers (powered by either denormalized datasets or relational database technology) have not been seen in any significant extent outside of the academic environment. Accordingly, there remains a need for a data classification and navigation system that can allow for faceted browsing of complex datasets comprising multiple collections of data records having multiple interrelationships with while being resource efficient, flexible and scalable.

### SUMMARY OF THE EMBODIMENTS

One embodiment of the invention comprises a method of generating, on a computer-readable medium, a collection of master data records and an accompanying inverted index from a data set, the data set comprising a plurality of distinct data record collections and at least some of the data records in the distinct data record collections being interrelated by association information, wherein for each master record, the method comprises: selecting a data record from the data set, and designating it the primary record for the chosen master data record; determining all other data records from the data set reachable from the primary record based on the association information, and designating said other data records as secondary records for said master data record; generating one or more tree-based data structures, each comprising one or more nodes, and storing the data from said primary record and said secondary records as nodes in said one or more tree-based data structure; storing said one or more tree-based data structures as said master data record; indexing the nodes of said one or more tree-based data structures to produce inverted index information; and adding said inverted index information to the inverted index; wherein the generated collection of master data records comprises all of the data from the data set, and further wherein the generated collection of master data records and associated inverted index facilitates pivoted faceted browsing of the data set in real time.

The collection of master data records may comprise all of the association information of the data set.

In an embodiment, each master data record comprises a single master tree-based data structure comprising the data from said primary record at a root node and the data from said secondary records at subsidiary branch nodes, wherein the branch nodes are ordered in accordance with said association information.

In another embodiment, each master data record may comprise a plurality of separate tree-based data structures, each tree structure corresponding respectively to one of said primary record and said secondary records, wherein each of said tree-based data structures is labelled, wherein the labels indicate an ordering of said tree-based data structures in accordance with said association information.

In a further embodiment, each master data record may comprise a plurality of separate tree-based data structures, each corresponding respectively to one of said primary record, and said secondary records.

In an embodiment, each master data record comprises a single master tree-based data structure comprising the data at least from said primary record at a root node, and wherein the master tree-based data structure further comprises at least one subsidiary branch node comprising a plurality of secondary tree-based data structures, each secondary tree-based data structure corresponding to a secondary data record.

A further embodiment of the invention comprises a computer readable medium encoded with a data superstructure (wherein a data superstructure is an organised collection of data structures) comprising a collection of master data records and an accompanying inverted index produced in accordance with the method of any of the embodiments described above.

An embodiment of the invention comprises a computer readable medium encoded with instructions thereon, which, when executed by a processor, cause the processor to carry out method of any of the embodiments described above.

A further embodiment of the invention comprises a system for precomputing a set of master data records and associated inverted index, the system comprising means for performing the steps of the method of any of the embodiments described above.

The system may further comprise: a data storage; a processor; a facet synthesis engine for performing the steps of selecting, determining, generating and storing; a tree-structured indexing engine for performing the steps of indexing and adding; and a tree-structured inverted index. As such, the facet synthesis engine may comprise the means for selecting, determining, generating and storing, and the tree-structured indexing engine may comprise the means for indexing and adding.

A further embodiment of the invention may comprise a system for navigating a set of master data records and associated inverted index, comprising: a computer readable medium encoded with a data superstructure comprising a collection of master data records and an accompanying inverted index produced in accordance with the method of any of the embodiments of the invention; a query engine; and a navigation engine.

Another embodiment of the invention comprises use, by a client device, of the computer readable medium comprising a collection of master data records and an accompanying inverted index produced in accordance with the method of any of the embodiments of the invention wherein the computer readable medium is accessible by the client device over a network.

A further embodiment of the invention comprises use, by a client device, of the system for navigating in accordance with any embodiment of the invention, wherein the computer readable medium is accessible by the client device over a network.

Compared to prior art systems and methods for facilitating pivoted, faceted browsing, the above embodiments of the invention are advantageous because the majority of the data processing is performed prior to an actual browsing/navigation operation by a user. Accordingly, the processing resources required during a browsing/navigation operation based embodiments of the invention are substantially reduced compared to many prior art systems, but particularly with respect to prior art systems utilising relational database technology. As such, the above invention is more efficient, and less resource-intensive than prior art systems, and easily allows real-time browsing of complex data sets, even where the data sets are distributed over a plurality of independent data record collections. Furthermore, the above invention facilitates a browsing/navigation operation that does not result in the return of duplicate data in the search results. Accordingly, the above invention does not require additional processing resources to handle/strip out duplicate data prior to presentation of the data in the navigation system. As such, the method of the invention has further efficiencies in this regard when compared to prior art systems, many of which produce duplicate search results, and must utilise potentially processor-intensive post-query processing to strip duplicate results out of a query. Further still, embodiments of the invention utilise materialized/denormalised data sets that have the potential to be not as large as prior art materialized/denormalized data sets, providing an improvement in terms of required storage space. In addition, embodiments of the invention are improvements over the prior art because the materialization/denormalization processes utilized in embodiments of the invention result in materialized data sets that do not lose information concerning the path to which a record belongs, do not lose information concerning the distinction of records, and do not lose information concerning the distinction between values of a multi-valued facet.

In view of the above advantages of embodiments of the invention, it will be appreciated that the method and system of the invention may be particularly useful for dealing with extremely large, interconnected data record collections such as are commonly used in scientific research. In particular in invention may be of use interrelating and facilitating the navigation/browsing of genetic, genomic, proteomic, biochemical, pharmaceutical, chemical and other types of scientific data. However a skilled person will readily appreciate that this is merely one field where the invention may find use, and it is equally applicable in any field where large, interconnected but distinct collections of data records are commonplace.

### BRIEF DESCRIPTION OF THE DRAWINGS

Embodiments of the invention will be described, by way of example only, with reference to the accompanying drawings in which:

FIG. 1 is a diagram illustrating the schema of the example dataset.

FIG. 2 is a schematic illustration of the data records of the example dataset.

FIG. 3 is a diagram illustrating the master data record derived from the first denormalisation approach and from the record “ArtWork 2” of the example dataset.

FIG. 4 is a diagram illustrating the master data records derived from the second denormalisation approach and from the record “ArtWork 2” of the example dataset.

FIG. 5 is a block diagram of the high level architecture of the system that is in charge of creating the tree-structured inverted index for the relational faceted search system.

FIG. 6 is a block diagram of the high level architecture of the relational faceted search system.

FIG. 7 is a diagram illustrating the tree-based facet synthesis for the record record “Museum 1”

FIG. 8 is a diagram illustrating the tree-based facet synthesis for the record “ArtWork 1”

FIG. 9 is a diagram illustrating the tree-based facet synthesis for the record “Artist 1”

FIG. 10 is a diagram illustrating the reachability-based synthesis for the record “Museum 1”

FIG. 11 is a diagram illustrating the reachability-based synthesis for the record “ArtWork 1”

FIG. 12 is a diagram illustrating the reachability-based synthesis for the record “Artist 1”

FIG. 13 is a diagram illustrating a possible tree structure for the record “ArtWork 1” that will be indexed by an inverted index.

FIG. 14 is a diagram illustrating a possible tree structure for the record “ArtWork 1” that will be indexed by an inverted index.

FIG. 15 is a diagram illustrating a possible tree structure for the record “ArtWork 1” that will be indexed by an inverted index.

FIG. 16 is a diagram illustrating a query tree with a focus on the ArtWork data collection.

FIG. 17 is a diagram illustrating the same query tree than in FIG. 16 but with a focus on the Museum data collection.

FIG. 18 is a series of diagrams illustrating the query tree rotation.

FIG. 19 is a diagram illustrating the query tree from FIG. 16 for the single inverted index embodiment.

FIG. 20 is a diagram illustrating the input and the data flow of the facet synthesis process in accordance with an embodiment of the present invention.

FIG. 21 is a diagram illustrating the operation flow of a user navigation.

FIG. 22 is a diagram illustrating the inputs and data flow of a method for composing index retrieval queries in response to user actions.

FIG. 23 is a diagram illustrating the problem of record explosion.

FIG. 24 is a diagram illustrating the tree-reachability hybrid embodiment of the invention.

FIG. 25 is a diagram illustrating the labelled reachability embodiment of the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

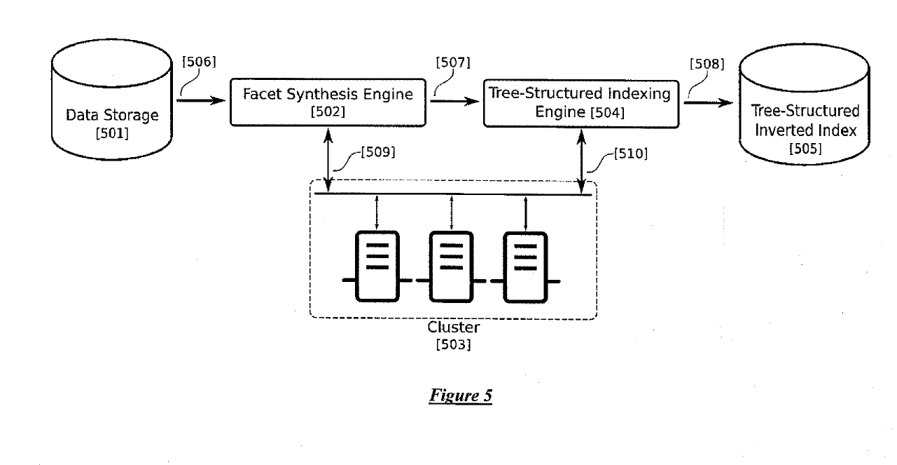

FIG. 5 shows a block diagram of the high level architecture of a system that is in charge of creating a tree-structured inverted index for a relational faceted search system in accordance with an embodiment of the invention. In this embodiment, the Data Store [501] is a general backend capable of storing and indexing large collections of semi-structured data and provides in an efficient manner the data that the algorithms of the Facet Synthesis Engine [502] requires to run. The Data Store [501] may be a simple file-based system storage, or a more complex system, for example, a relational database that can be queried. Facet Synthesis Engine [502] comprises the implementation of various facet synthesis algorithms. Facet Synthesis Engine [502] processes the semi-structured data from the Data Store [501] and generates a facet synthesis of the semi-structured data. The Facet Synthesis Engine may communicate with the Data Store [501] over a network reliant connection [506]. Tree-Structured Indexing Engine [504] comprises the implementation of algorithms that processes a facet synthesis and generates a Tree-Structured Inverted Index [505]. The Tree-Structured Indexing Engine [504] may communicate with the Facet Synthesis Engine [502] and with the Tree-Structured Inverted Index [505] over network reliant connections [507], [508] respectively. Facet Synthesis Engine [502] and Tree-Structured Indexing Engine [504] rely on Cluster [503], a cluster of computers, and can communicate with the cluster through network reliant connections [509, 510]. While Cluster [503] is described in terms of a cluster of computers, it may also be a single server or computer. While communication links [506, 507, 508, 509, 510] are described in terms of network reliant connections, communication may alternatively take place locally through direct links for some or all of these connections. For other embodiments of the invention, a similar system may be used, wherein the Tree-Structured Indexing Engine [508] is modified to produce the materialized view of the data in accordance with the embodiment in question. Typically, the materialized view of each embodiment will comprise a constituent tree-structured inverted index for a relational faceted search system forming at least part of the materialized view of the data,

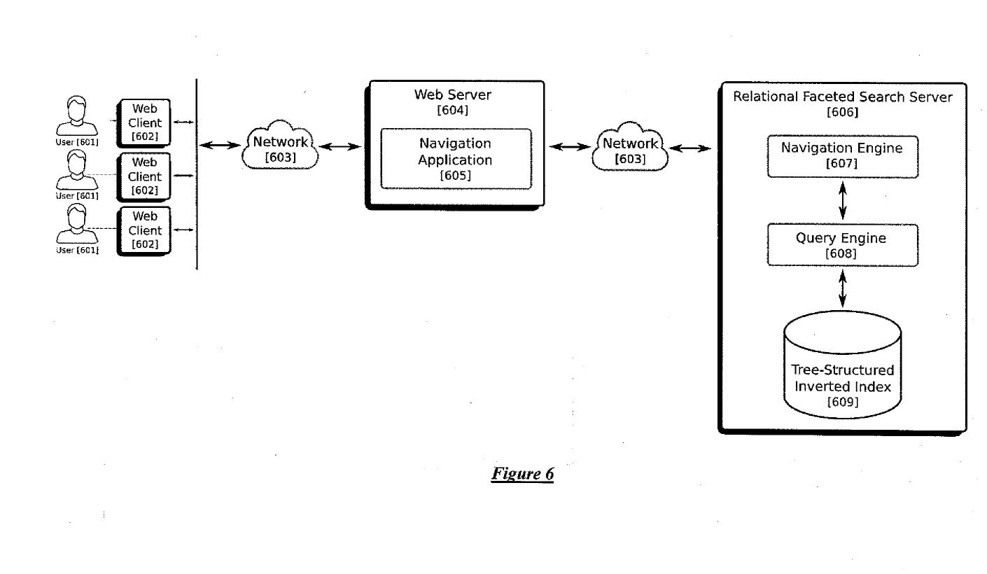

FIG. 6 shows a block diagram of the high level architecture of the relational faceted search system in accordance with an embodiment of the present invention. The system includes one or more web clients [602], a web server [604] and a relational faceted search server [606]. These entities are coupled together by a network [603], which can generally include any type of wired or wireless communication channel capable of coupling together computing nodes. This includes, but is not limited to, a local area network, a wide area network, or a combination of networks. In one embodiment of the present invention, the network includes the Internet. Web clients [602] can generally include any node on the network including computational capability and including a mechanism for making service requests across the network. A web client [602] is associated with a user [601] who runs applications on web client [602]. Web server [604] can generally include any computational node including a mechanism for servicing requests from a client for computational and/or data storage resources. Web server [604] generally services requests from web clients [602]. Note that web server [604] is itself a client of relational faceted search server [606]. More specifically, a navigation application [605] on web server [604] interacts with relational faceted search server [606]. Relational faceted search server [606] uses a tree-structured inverted index [609] to facilitate navigation through information resources in accordance with an embodiment of the present invention. More specifically, relational faceted search server [606] performs searches and related navigational operations involving data stored and indexed within a tree-structured inverted index [609]. To this end, relational faceted search server includes a navigation engine [607] that facilitates navigational operations and translates them into appropriate queries, and a query engine [608] that executes queries on the data contained within the tree-structured inverted index [609]. During operation, web server [604] submits a query to the relational faceted search server [606]. In response to the query, the relational faceted search server [606] returns a response. The response contains enough information to allow web server [604] to refine the query without having to maintain state information about the query on the relational faceted search server [606]. It will be appreciated (as will be discussed further below) that in other embodiments of the invention, tree-type data structures may not be used exclusively to comprise full master data records. Rather, master data records may comprise collections of one or more tree-based data structures in conjunction with other data ordering means. With respect to such embodiments, a similar system to that depicted in FIG. 6 is used, whereby a tree-structured inverted index is used initially to navigate the materialized view of the data, with other, subsequent approaches being used to complete the search, these subsequent approaches being commensurate with and appropriate for the other data ordering means in question. Examples of such other data ordering means will be provided below, and the approaches suitable for navigating these means will be readily appreciated and understood by one of skill in the art.

As previously discussed, existing solutions for enabling relational faceted browsing very quickly show their limitations in terms of performance by forcing the user to wait long periods of time even on fully-functional systems and for moderately sized datasets. The claimed invention, by contrast, allows relational faceted browsing at realtime speed, typically with just a few milliseconds between user action and updated user interface. This is obtained thanks to multiple chained steps that ultimately precompute a specific index that can be queried in response to user actions. This approach represents a significant departure from the prior art in how faceted browsing is achieved.

In short, aspects of the invention may comprise the steps of:
1. Facet synthesis;
2. Encoding facet synthesis into an inverted index; and
3. Inverted index querying in response to user action

### Method for Performing a Facet Synthesis on a Domain of Information

In this step—facet synthesis—a materialized view is created which is specifically suitable to facilitate relational faceted browsing whilst at the same time matching the high performance capabilities of inverted indices as will be discussed further below. This materialization is the result of a denormalization of the graph (as defined by graph theory) that is representative of all of the interrelationships of all data in the data set, and represents a more suitable model for efficient indexing and querying using an inverted index. In each embodiment, a collection of master data records are produced, wherein each master data record comprises the data from a first data record from the data set (designated the “primary” record) and the data from data records that are reachable along at least one “path” emanating from the primary record according to the interrelationships between the data records. These reachable data records are designated “secondary” records.

In a first embodiment (the “tree-based synthesis”) the materialized structure comprises a set of master data records, each master data record based exclusively on a single master tree-type data structure comprising a series of nodes, the data from the primary data record being stored as the root node, and the data from the associated secondary nodes being stored as subsidiary branch nodes and ordered in accordance with their relationship to the primary data record. This method is exact and precise, because faceted browsing based on tree-based structures will not return false positive results. However, in some cases this approach can suffer from high complexity. An alternative embodiment of the invention (the “reachability-based synthesis”) is also envisaged. This reachability embodiment produces a materialized structure based on the graph reachability concept, wherein a primary data record is aggregated with secondary data records that are reachable along at least one “path” emanating from the primary record. Each aggregation of records is stored as a master data record and each record in each aggregation is materialized in the master data record as a tree data structure. This embodiment trades precision for a much lower complexity. A third embodiment (the “tree-reachability hybrid synthesis”) is further envisaged. Like the tree embodiment, each master data record of the tree-reachability hybrid embodiment comprises a master tree-type data structure wherein the data from the primary record is stored at a root node. This master tree-type data structure further comprises at least one subsidiary branch node comprising a collection of a plurality of secondary tree-based data structures, each secondary tree-based data structure storing the data of (and thus corresponding to) a secondary data record. The complexity and precision of this embodiment is variable between the two extremes presented by the tree-based synthesis embodiment and the reachability-based synthesis embodiment. The more N:N and N:1 relational data represented in the collection of secondary tree-based structures, the closer this embodiment will be in terms of complexity and precision to the reachability embodiment, A fourth embodiment (the “labelled reachability-based synthesis”) is also envisaged. Like the reachability embodiment, each master data record of the labelled reachability embodiment comprises an aggregation of a primary data record and associated secondary data records, each in the form of a tree-type structure. However, the relationship between the various secondary data records and the primary data record is preserved by applying labels to each individual record. This approach preservers total precision, and also has a reduced final complexity compared to certain other embodiments. As such, the alternative embodiments for facet synthesis which achieve slightly different results with different costs.

### Tree-Based Synthesis

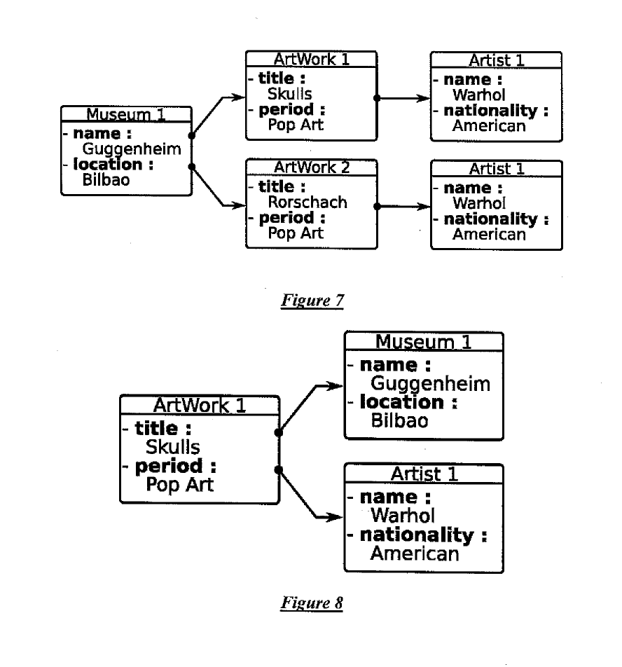

Facet synthesis of this type can be seen as denormalization that will materialize different views of the data graph. It is achieved by precomputing for each primary data record all the existing paths to secondary data records in other data record collections to produce a single tree-based data structure that is representative of all data in all secondary records residing on any path emanating from the designated primary record, this data being ordered on the tree in a manner representative of the relationship with the primary record. After synthesis, each primary data record, of each of the possible types, will be associated to the root of a tree where each branch of the tree encodes one path linking it to the other secondary records. As such, facet synthesis for the tree based synthesis embodiment of the invention results in a collection of master data records, each master data record comprising a tree-type data structure. FIG. 7, FIG. 8 and FIG. 9 depict a few master data records extracted from the different data collections of the example dataset from FIG. 2.

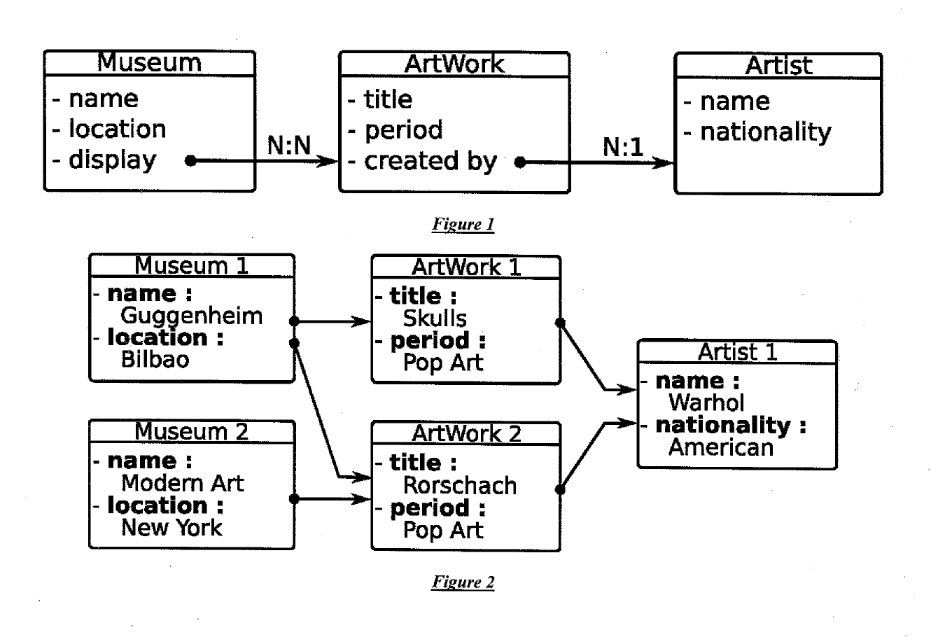

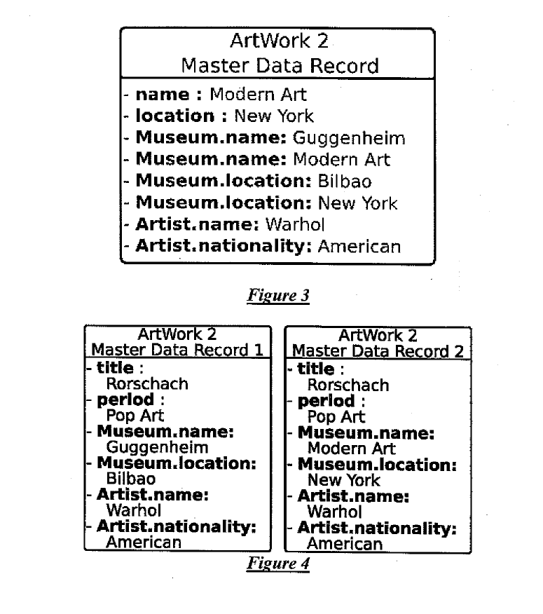

In the case of many-to-many relationships between two data record collections (as illustrated by the relationship between Museums and Artworks in FIG. 1), and many-to-one relationships between two data record collections (such as illustrated by the relationship between Artworks and Artists in FIG. 1), the system materializes the data into a one-to-one relationship form as exemplified in FIG. 7. The consequence is that certain data records are duplicated even within a single tree across multiple branches, such as for example the record “Artist 1” in FIG. 7. In general, this approach may duplicate records having a N:1 or N:N relationship. At this stage, also, any relationship is given an “inverse” counterpart and this inverse relationship is also materialized. For example in FIG. 8, the relationship between “ArtWork 1” and “Museum 1” is materialized as the inverse of the original relationship represented by the “display” facet from the data record collection “Museum” in FIG. 1. As such, while the original relationship was representative of “has displayed” (i.e. indicating the Artworks a Museum has displayed), the inverse relationship will be representative of “displayed in” (i.e. Museums in which an Artwork has been displayed). In some embodiments, this materialised view can be computed using database technologies, e.g., query execution planning joining data record tables, or graph searching algorithms, e.g., breadth-first search. In other embodiments this can be computed on a large scale using distributed computing techniques such as the MapReduce paradigm.

In this embodiment, there is no loss of information concerning the path to which a record belongs (to the extent the reachability embodiment is utilised), concerning the distinction of records or concerning the distinction between values of a multi-valued facet. Particularly in view of the fact that a tree-based inverted index is used, multi-valued facets will not be dernomalised into one single value through concatenation. It should also be noted that while duplicate records may arise in the synthesis process in this embodiment, the way by which this data is interrogated (through use of an inverted index) ensures that no duplicate results appear in search queries returned from data sets represented by materialized views in accordance with this embodiment of the invention.

### Reachability-Based Synthesis

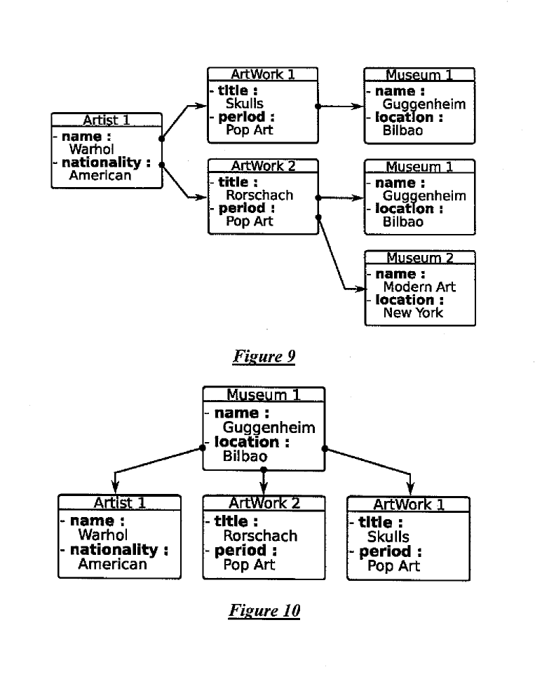

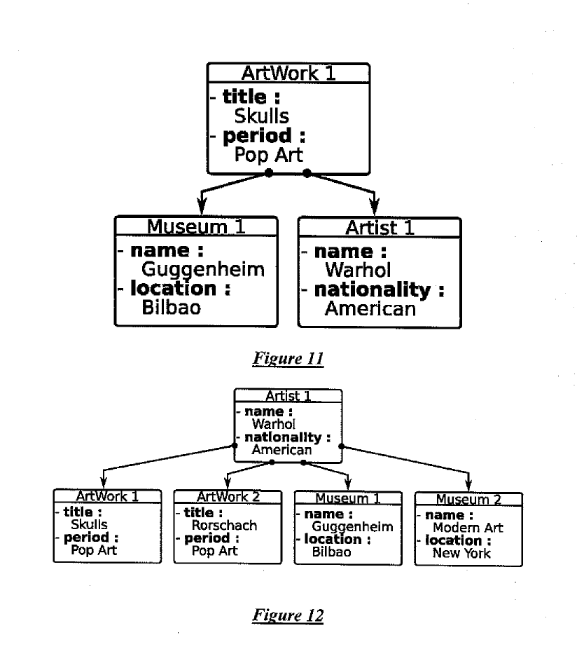

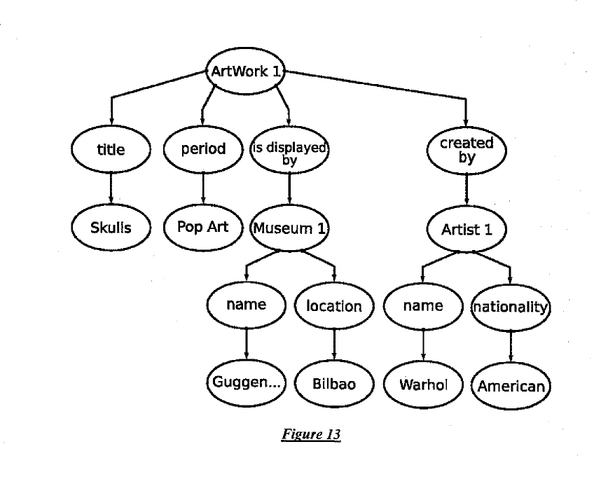

Facet synthesis of this type is based on the reachability concept in graph theory and has a considerably lower (space and time) complexity than the tree-based synthesis embodiment. Instead of computing a fully tree-based materialized view comprising the paths from one primary data record to all the secondary data records from other collections, this method computes a materialized view comprising master data records each of which comprises an aggregation of all the secondary data records from the other data collections that are reachable from one designated primary data record, along with the designated primary data record. A secondary data record is considered reachable by a primary data record if and only if a path exists between these two records. Compared to the tree-based synthesis, the sequence of data relations that constitute the path between the primary data record and a reachable secondary data record is not kept. Instead a simpler relation (“is related to”) is generated between the primary data record and the secondary data record. In other words, the reachability-based synthesis comprises associating each primary data record with its set of reachable secondary data records, and aggregating these records into a single master data record. In addition, each primary and secondary record within each master data record is then converted from the traditional list of “attribute-value” pairs to a tree-based data structure. The result is that each master data record comprises an aggregation of a primary record and all reachable secondary records wherein each of the primary and secondary records are represented as tree-based data structures. It is important to note that this synthesis produces master data records without duplication of records. FIG. 10, FIG. 11 and FIG. 12 depict a few master data records extracted from the different data collections of the example dataset from FIG. 2.

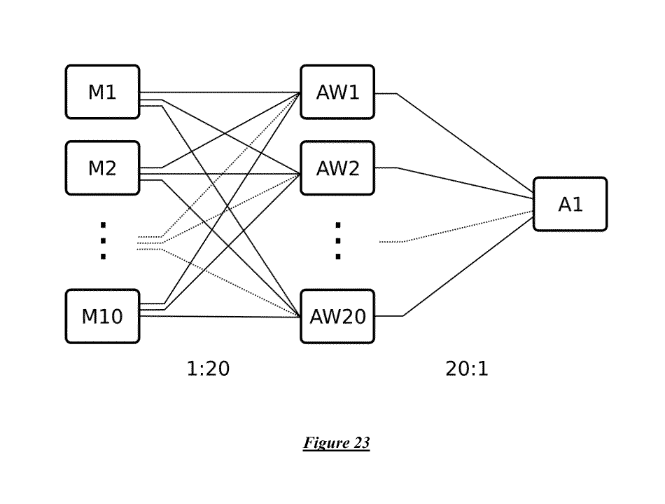

With respect to the size of a set of master data records comprising a reachability-based materialized view, the worst case complexity is less than that of the prior art “second denormalization” solution.For the reachability embodiment, the worst case complexity becomes O(K+M)*N+O(K+N)*M+O(M+N)*K instead of O(K*M*N). Referring back to the Example of FIG. 23, while implementation of the second denormalization approach, as disclosed in the prior art would result in 600 master data records, the reachability-based approach would result in a collection of 10 Museum master records, 20 ArtWork master records, and one Artist master record, wherein each Museum master record comprises 22 records, each ArtWork master record comprises 12 records and each Artist master record comprises 31 records. Accordingly, this approach would increase the size of the dataset to 491 records.

However, compared to the tree-based synthesis embodiment of the present invention, information is lost as relations between data records are not kept. Due to this, potential loss of information, it is possible that a different end result is obtained from a browsing operation. Hence, while the system will apparently look and behave identically to a system using the tree-based synthesis approach, there will be a possible difference in the results provided to a user at any iterative refinement step.

The easiest way to explain these differences is that of “precision”: the system will provide all the results that were previously available (no false negatives) but could also be “less precise” as it could include some false positives. In the event the system is implemented using reachability-based synthesis it could be drawn to the attention of the user.

In this embodiment, there is a loss of information concerning the path to which a record belongs (to the extent the reachability embodiment is utilised), but there is no loss of information concerning the distinction of records or concerning the distinction between values of a multi-valued facet. Furthermore, this embodiment of the invention ensures that no duplicate results are either synthesized in the materialization or returned in a search query.

### Tree-Reachability Hybrid Synthesis

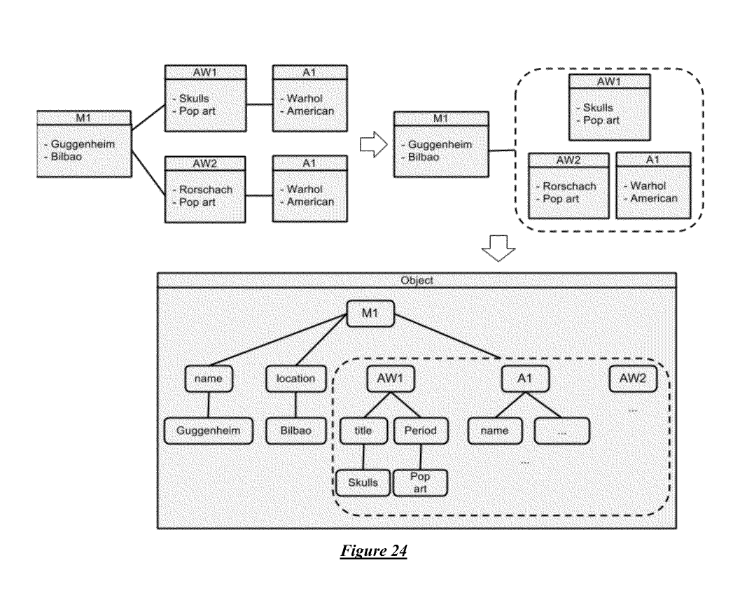

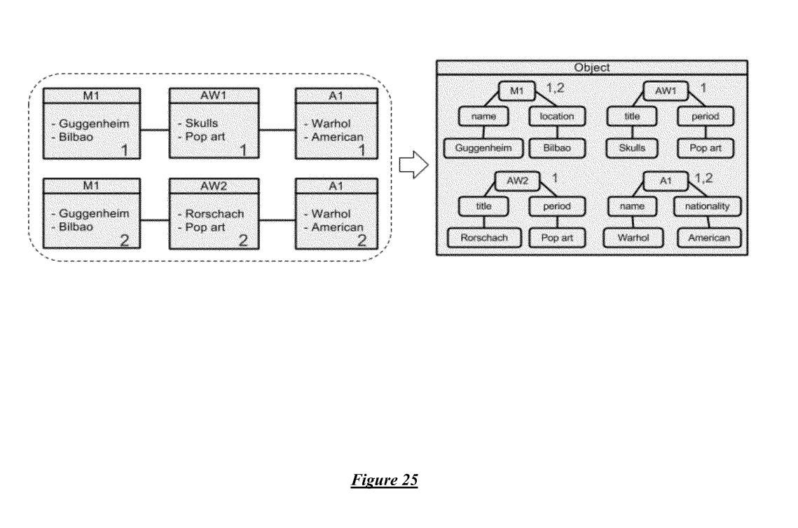

As the name suggests, this embodiment is a combination of the two preceding approaches. To produce a master data record, the data of the primary data record and secondary data records are all mapped to a single master tree-type structure, with the data from the primary record stored at a root node. However, one or more branches of the tree comprising data from a plurality of secondary data records are then flattened into an aggregation of independent secondary tree-type structures, akin to the aggregation of records that comprise master data records in the reachability embodiment of the invention. Each secondary tree-based data structure stores the data of (and thus corresponds to) an individual secondary data record. In this embodiment, to the extent that the tree embodiment is used, association information illustrating the path between the primary data record and the secondary records is preserved. This process is exemplified in FIG. 24. As such, in this embodiment, there is partial loss of information concerning the path to which a record belongs to the extent the reachability embodiment is utilised. At the same time, duplicate records are also avoided in the synthesis to the extent the reachability embodiment is utilised, and duplicate records are completely avoided in responses to search queries. Furthermore, there is no loss of information concerning the distinction of records or concerning the distinction between values of a multi-valued facet. However, the extent to which the reachability embodiment is utilised also dictates the extent to which computational complexity of this embodiment is reduced.

### Labelled Reachability Based Synthesis

To produce a master data record in accordance with the labelled reachability based synthesis, all paths emanating from a designated primary data record are plotted and each data record lying along each path is labelled with an identifier that is representative of the path in question. If a data record lies on more than one path, then it is assigned multiple labels, one corresponding to each path in question. The data from the primary data record and secondary data records are all then stored in individual tree-type data structures, in a fashion similar to the reachability embodiment of the invention. The labels assigned to each data record are likewise assigned to the corresponding trees. By the use of this labelling, the relationship between the various secondary data records and the primary data record is preserved. This approach is illustrated in FIG. 25. This approach preserves total precision, as there is no loss of information concerning the path to which a record belongs, concerning the distinction of records, or concerning the distinction between values of a multi-valued facet. From the perspective of computational complexity, it is still necessary to enumerate all possible paths, but this approach does not produce any duplicates either in the synthesis or in search query returns, and so the storage space required does not increase substantially, and additional computational resources are not needed to handle duplicate records at query time.

In the above embodiments, the materialized view can be computed using graph searching algorithms, e.g., breadth-first search or iterative deepening depth-first search, or using transitive closure algorithms using database or distributed computing technologies. It will be readily appreciated by a person of skill in the art that the above embodiments are by way of illustration only, and that further embodiments are also envisaged, wherein such further embodiments may comprise a combination of two or more of the above outlined approaches.

The steps performed in the above embodiments by which a materialized view of the data set is synthesised may be summarised by the process depicted in FIG. 20. At step [2001], a data store comprising the target data set is accessed. The data store may comprise a single storage unit, or alternatively, the data set may be distributed over a plurality of storage units. At step [2002], each data record that is to serve as the primary data record in a master data record is scanned, and the data comprised therein retrieved. At step [2003], association information that indicates what other data records (to be designated as “secondary” records) are reachable from (or associated with) the primary record is used to identify said secondary records, and the data in said secondary records is retrieved. At step [2004] a master data record is generated for each primary data record and its associated secondary records, the retrieved data from the primary record and secondary records being stored in the master data record. At step [2005], the master data records are then transmitted to the indexing engine for indexing.

Method for Encoding Facet Synthesis into an Inverted Index

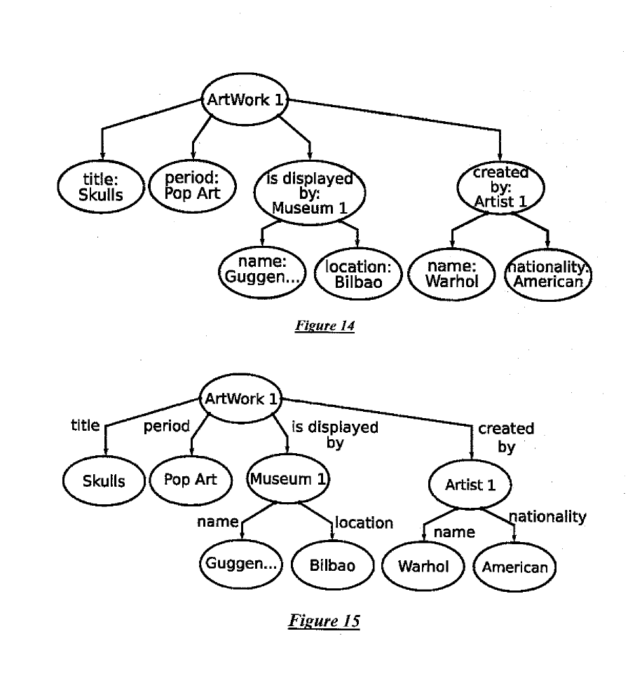

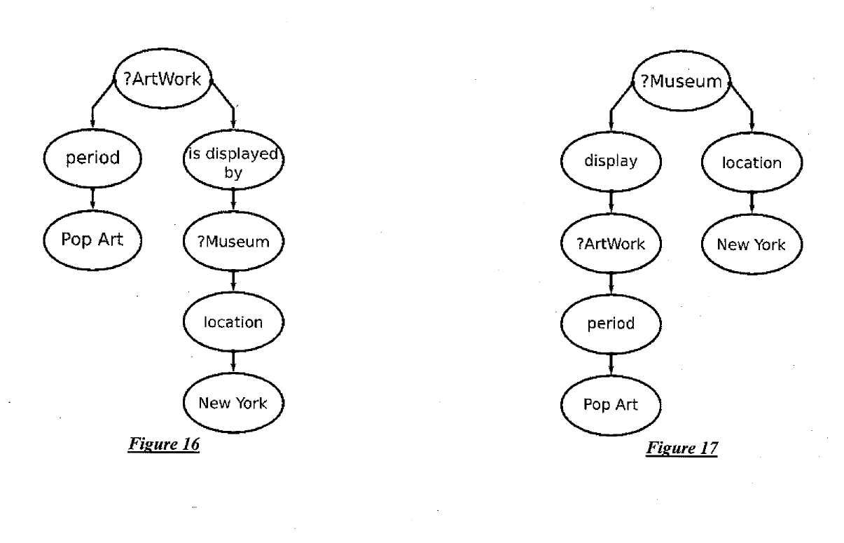

Inverted index data structures are commonly used to efficiently retrieve data records from simple, flat data structures, such as from a list of attribute-value pairs. However, it is not the case that inverted index structures are widely used to retrieve data from tree-type data structures. In accordance with an embodiment of the invention, once the previously discussed facet synthesis has been performed, the tree-type data structures in the materialized view are then mapped so that the materialized views can then be effectively searched by an inverted index system. In an embodiment, the nodes of the trees can represent records, attributes associated with the records, and values associated with these attributes. Such a tree is depicted in FIG. 13. In another embodiment, the nodes of the tree can represent records and attribute-value pairs. Such a tree is depicted in FIG. 14. In another embodiment, the nodes of the tree can represent records and values associated with attributes, while attributes are implicitly encoded by the relation between the nodes. Such a tree is depicted in FIG. 15. In other embodiments, the tree model can be a combination of these three models and/or variations of these models. Either of these embodiments can then be indexed efficiently using a node-labelled tree approach.

A node-labelled tree model enables one to encode and efficiently establish relationships between the nodes of a tree. The two main types of relations are parent-child and ancestor-descendant, which are also core operations in XML query languages such as XPath. To support these relations, the requirement is to assign unique identifiers, called node labels, that encode the relationships between the nodes. In some embodiments, a prefix scheme such as the Dewey Order encoding or other node labelling schemes can be used to label the nodes. For example, in the tree of FIG. 13, the root node “Artwork 1” may be assigned the unique code [1], with the node bearing the attribute “title” being assigned the code [1.1], and the node bearing the value “Skulls” the code [1.1.1]. By applying this approach, the node bearing the relationship “is displayed by” will be assigned the code [1.3], the node bearing the attribute “location” will be assigned the code [1.3.1.2], and the node bearing the value “American” will be assigned the code [1.4.1.2.1]. The node labelled tree is then embedded into an inverted index by taking each occurrence of each node value and storing the node label corresponding to that occurrence against the node value in the node index such that each value in the index is associated with a list of occurrences of the value in the node labelled tree.

In one of the embodiment of system, an index exists per record type, indexing all the record views about this record type that have been materialised during the facet synthesis step. In the example of FIG. 2, the faceted browser will then have 3 inverted indexes: the artist-index, the artwork-index and the museum-index.

In another of the embodiment of system, a single inverted index can be used as opposed to one per record type. In this case all the record views materialised during the facet synthesis step are stored together in the same index but are distinguished from each other with a specific “type value”, seen as an extra tree branch materialized in each record view, allowing the selection of only the relevant records from a particular type.

### Navigation, Including Method for Composing Index Retrieval Queries in Response to User Actions

An inverted index encoded as in the previous steps is capable of efficiently answering Boolean and containment relationship (Parent-Child and Ancestor-Descendant) queries on tree data structures. The relational faceted browsing can be then facilitated as a result of user actions by composing a query on the multiple inverted indexes (or on the single inverted index) as follows:

A navigation state of the faceted navigation system is composed of:
1. a set of constraints applied by the user to the information space;
2. a focus on a particular data record collection (typically the type of the record, e.g., Museum vs Artwork).

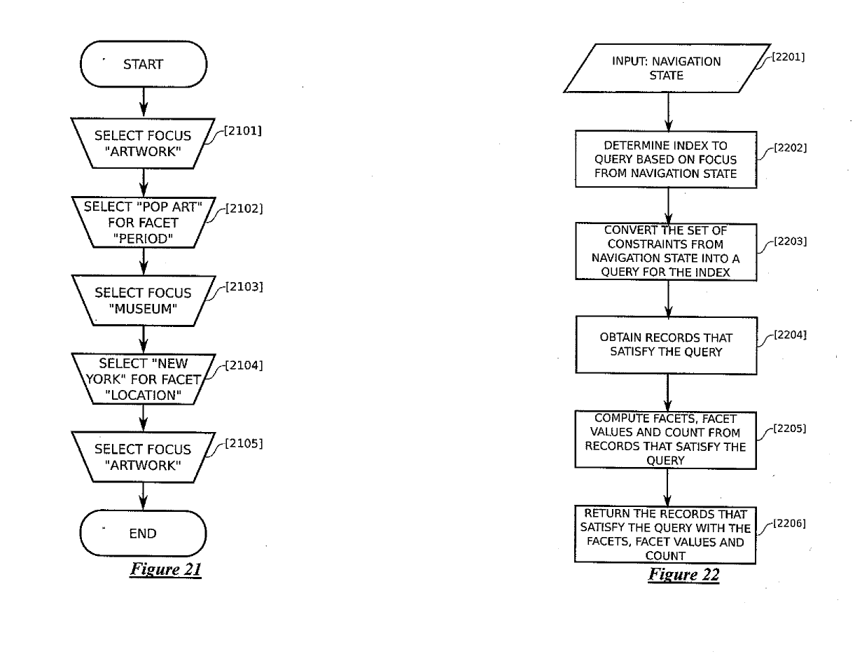

First of all the focus on a particular data record type (e.g., now we are looking at “Art work”) determines which inverted index is used for the query (e.g., the ArtWork-index in this case). Then a set of constraints is considered (e.g., “The period of the art work must be Pop Art, and the artwork must be located in New York”). FIG. 21 is representative of such a browsing process in action. At step [2101], a user first selects “Artwork” as their focus, and then at step chooses to limit the Artwork facet “period” to the value “Pop Art”. When the results meeting these constraints are returned, the user then, at step [2103] switches the focus to the “Museum” index. In a manner similar to step [2102], the Museum facet “location” is then limited to the value “New York” in step [2104]. When the results also meeting this further constraint are returned, at the step [2105], the focus is switched back to “Artwork”. At this point, the user is presented with a list of Artworks from the Pop Art period that have been displayed in New York Museums.

In logical notation this constraint query becomes:

(?ArtWork period=Pop Art) AND (?ArtWork is displayed by=?Museum) AND (?Museum location=New-York)

If the focus of the faceted browser is “ArtWork”, the content of the view is obtained by selecting the ArtWork index and casting the above query as a tree query following the view model that has been materialised during the facet synthesis. This query tree is shown, in graphical notation, in FIG. 16, the node labels “?ArtWork” and “?Museum” represent variables associated to their respective data record collection. The variable that is retrieved by the system is the root node “?ArtWork” of the query tree illustrated in FIG. 16.

The query composition is performed automatically in a way that considers the view model that has been materialised during the facet synthesis. The query will therefore be tree-shaped itself, with the tree possibly being as deep and wide as the corresponding view model. For example, if the user was to focus on “Museum” the same identical constraint query must be written to be executed on top of the Museum-index—which reflects the view model of the facet synthesis for the Museum record collection. Following the algorithm below, the query in graphical notation would then look as the one illustrated in FIG. 17.

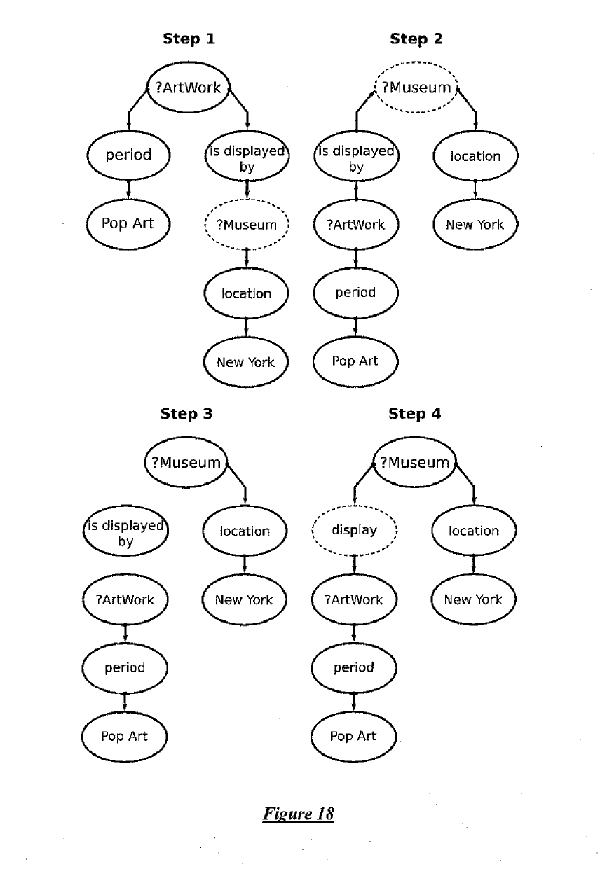

The query tree rewriting is performed automatically to form the new query tree as follows, which can be seen as a rotation of the root node of the query tree:
1. Find the variable that is relative to the new focus using tree search algorithms (e.g., ?Museum in the previous example) as illustrated by “Step 1” of FIG. 18.
2. Set such a variable as root of the query tree as illustrated by “Step 2” of FIG. 18. Change the direction of the left-hand side edges connecting the new root node to the previous root node (e.g., the edge connecting ?ArtWork to “is displayed by” and the edge connecting “is displayed by” to ?Museum) as illustrated by “step 3” of FIG. 18.
3. Replace the relationship connecting the root node to the previous root node by its inverse equivalent. For example, the relationship “is displayed by” between “?Artwork” and “?Museum” is rewritten into the relationship “display” between “?Museum” and “?ArtWork” as illustrating by “Step 4” of FIG. 18.

In practice, the execution of the query exemplified by FIG. 16 would proceed in accordance with the inputs and data flow illustrated in FIG. 22. At step [2201], the navigation state comprising the “focus” is input into the navigation engine [607]. As discussed with respect to FIG. 16 above, the initial focus is “Artwork”. At step [2202], the index to query is determined based on the focus of the navigation state (in this case, the Artwork index). The user may elect certain constraints based on the presented facet values (in the example discussed with respect to FIG. 16, the value “Pop Art” is selected with respect to the facet “period). In other examples, more than one constraint may be applied at this stage. Subsequently, at step [2203], the constraint set is converted from a navigation state to a query for the index. At step [2204], the records are retrieved that meet the constraints of the query, at step [2205] the facets and facet values of the retrieved records are computed and counted, or—put another way—ennumerated and aggregated. Facets and facet values are ennumerated by the inverted index based on an internal data structure (usually a dictionary). For each facet value, the system will intersect the list of record ids (integers) from the current record set with the list of record ids associated to this facet value. From this, it will derive a new list of record ids, which represents the record ids from the current record set that satisfies this facet value. From this list, a count is computed for the facet value. There are multiple optimisations to reduce the number of computations during facet enumeration and count, but such optimisations are normally well known by a person of skill in the art. Subsequently, at step [2206], the facets, facet values and count of the records that satisfy the query are returned for formatting so that they may be presented via the navigation system. This process may then be repeated where the focus is subsequently shifted, such as—in the example of FIG. 16—where the focus is shifted to the “Museum” index, wherein the dataset is further constrained by the Museum facet “location” which is limited to the value “New York” in step [2104].

### Single Inverted Index Embodiment

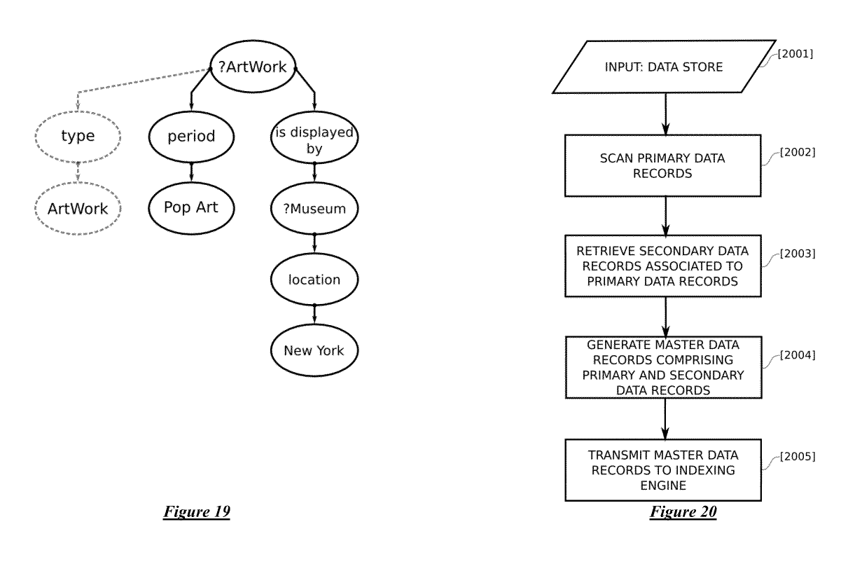

In another of the embodiment of system, a single inverted index can be used as opposed to a separate index per record type as explained above in the section “Method for encoding facet synthesis into an inverted index”. In this case, FIG. 19 shows an example of a tree query that encodes the same constraint query as in FIG. 16 but adds the additional entity type branch allowing the selection of only the relevant entities.

### OTHER EMBODIMENTS

While the above navigation method is described in the context of the tree-based synthesis model, it will be appreciated that similar navigation approaches will work for the other embodiments of the invention, all of which make use of tree-type data structures to some extent. While some modifications to the navigation approach may be necessary, a skilled person would appreciate how to implement such approaches. For all of the approaches, a set of constraints can always be converted into a logical notation, and into a corresponding query tree. The algorithm that is described to perform the change of focus on the query tree will be the same. What can change is how the query engine [608] of each embodiment will internally execute this abstract query tree. In the case of the tree-based, reachability, and tree-reachability hybrid embodiments, this will be performed with the use of Parent-Child and Ancestor-Descendant operators, as explained above. In the case of the labelled reachability based synthesis, then an additional operator is necessary in order to match the path identifiers across the occurrences of the matching query terms. As stated above, a skilled person would readily appreciate the modifications required along such lines.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method of generating, on a computer-readable medium, a collection of master data records and an accompanying inverted index from a data set, the data set comprising a plurality of distinct data record collections and at least some of the data records in the distinct data record collections being interrelated by association information, wherein for each master record, the method comprising:
selecting a data record from the data set and designating the selected data record as a primary record for a chosen master data record;
determining all other data records from the data set reachable from the primary record based on the association information, and designating said all other data records as secondary records for said master data record;
generating one or more tree-based data structures, each comprising one or more nodes, and storing data from said primary record and said secondary records as nodes in said one or more tree-based data structure;
storing said one or more tree-based data structures as said master data record;
indexing the nodes of said one or more tree-based data structures to produce inverted index information; and
adding said inverted index information to the inverted index;
wherein the generated collection of master data records comprises all of the data from the data set, and further wherein the generated collection of master data records and associated inverted index facilitate pivoted faceted browsing of the data set in real time.

2. The method of claim 1, wherein the collection of master data records further comprises all of the association information of the data set.

3. The method of claim 2, wherein each master data record comprises a single tree-based data structure comprising the data from said primary record at a root node and the data from said secondary records at subsidiary branch nodes, wherein the branch nodes are ordered in accordance with said association information.

4. The method of claim 2, wherein each master data record comprises a plurality of separate tree-based data structures, each respectively corresponding to one of said primary record and said secondary records, wherein each of said tree-based data structures is labelled to indicate an ordering of said tree-based data structures in accordance with said association information.

5. The method of claim 1, wherein each master data record comprises a plurality of separate tree-based data structures, each respectively corresponding to one of said primary record and said secondary records.

6. The method of claim 1, wherein each master data record comprises a single master tree-based data structure comprising the data at least from said primary record at a root node, and wherein the master tree-based data structure further comprises at least one subsidiary branch node comprising a plurality of secondary tree-based data structures, each secondary tree-based data structure corresponding to a secondary data record.

7. A computer readable medium encoded with a data superstructure comprising a collection of master data records and accompanying inverted index produced by generating, on the computer-readable medium, a collection of master data records and an accompanying inverted index from a data set, the data set comprising a plurality of distinct data record collections and at least some of the data records in the distinct data record collections being interrelated by association information, wherein for each master record, the method comprising:
selecting a data record from the data set and designating selected data record as a primary record for a chosen master data record;
determining all other data records from the data set reachable from the primary record based on the association information, and designating said all other data records as secondary records for said master data record;
generating one or more tree-based data structures, each comprising one or more nodes, and storing data from said primary record and said secondary records as nodes in said one or more tree-based data structure;
storing said one or more tree-based data structures as said master data record;
indexing the nodes of said one or more tree-based data structures to produce inverted index information; and
adding said inverted index information to the inverted index;
wherein the generated collection of master data records comprises all of the data from the data set, and further wherein the generated collection of master data records and associated inverted index facilitates pivoted faceted browsing of the data set in real time.

8. A computer readable medium encoded with instructions thereon, which, when executed by a processor, cause the processor to carry out a method of generating, on the computer-readable medium, a collection of master data records and an accompanying inverted index from a data set, the data set comprising a plurality of distinct data record collections and at least some of the data records in the distinct data record collections being interrelated by association information, wherein for each master record, the method comprising:
selecting a data record from the data set and designating the selected data record a primary record for a chosen master data record;
determining all other data records from the data set reachable from the primary record based on the association information, and designating said all other data records as secondary records for said master data record;
generating one or more tree-based data structures, each comprising one or more nodes, and storing the data from said primary record and said secondary records as nodes in said one or more tree-based data structure;
storing said one or more tree-based data structures as said master data record;
indexing the nodes of said one or more tree-based data structures to produce inverted index information; and
adding said inverted index information to the inverted index;
wherein the generated collection of master data records comprises all of the data from the data set, and further wherein the generated collection of master data records and associated inverted index facilitates pivoted faceted browsing of the data set in real time.

9. A system for precomputing a set of master data records and associated inverted index comprising a processor structured to perform a method comprising:
generating a collection of master data records and an accompanying inverted index from a data set, the data set comprising a plurality of distinct data record collections and at least some of the data records in the distinct data record collections being interrelated by association information,
wherein for each master record, the method further comprising:
selecting a data record from the data set and designating the selected data record a primary record for a chosen master data record;
determining all other data records from the data set reachable from the primary record based on the association information, and designating said all other data records as secondary records for said master data record;
generating one or more tree-based data structures, each comprising one or more nodes, and storing the data from said primary record and said secondary records as nodes in said one or more tree-based data structure;
storing said one or more tree-based data structures as said master data record;
indexing the nodes of said one or more tree-based data structures to produce inverted index information; and
adding said inverted index information to the inverted index;
wherein the generated collection of master data records comprises all of the data from the data set, and further wherein the generated collection of master data records and associated inverted index facilitates pivoted faceted browsing of the data set in real time.

10. The system of claim 9 comprising:
a data storage;
a facet synthesis engine comprising the means for performing the steps of selecting, determining, generating and storing;
a tree-structured indexing engine comprising the means for performing the steps of indexing and adding; and
a tree-structured inverted index.

11. A system for navigating a set of master data records and associated inverted index, comprising:
the computer readable medium of claim 7;
a query engine; and
a navigation engine.

12. A method of use, by a client device, of the computer readable medium of claim 7, wherein the computer readable medium is accessible by the client device over a network.

13. A method of use, by a client device, of the system of claim 9, wherein the computer readable medium is accessible by the client device over a network.
